(19) United States
(12) Patent Application Publication
(10) Pub. No.: US 2007/0192764 A1
(43) Pub. Date: Aug. 16, 2007

(54) AN APPLICATION COMPRISING A NETWORK SETTING

(75) Inventor: Par-Anders Aronsson, Klagshamn (SE)

Correspondence Address: ALBIHNS STOCKHOLM AB, BOX 5581, LINNEGATAN 2, SE-114 85 STOCKHOLM; SWEDENn, STOCKHOLM, SE

(73) Assignee: Sony Ericsson Mobile Communications AB, Lund (SE)

(21) Appl. No.: 11/379,066

(22) Filed: Apr. 18, 2006

Related U.S. Application Data
(60) Provisional application No. 60/597,442, filed on Dec. 2, 2005.

(51) Int. Cl. G06F 9/44

(52) U.S. Cl. 717/168; 717/120

(57) ABSTRACT

The invention relates to an application comprising a network setting. The invention provides an application comprising code for running in a mobile station platform, including one function involving connection over a network. The application further comprises information referring to network settings. In one embodiment, said information is dependent of a connection to be established by the application.

### FIELD OF THE INVENTION

The present invention relates to an application comprising a network setting, and more particularly an application for running in a mobile station, wherein the application is especially adapted for a current connection.

### BACKGROUND OF THE INVENTION

Many functions in mobile stations, such as mobile telephones, are implemented as Java applications. A Java application is a program module in a language that is platform independent. Moreover, some functions need to establish connections over a network. When an application encounters an instruction to create a connection, the application further needs definitions of what network to use, transfer rate, communication method et cetera, commonly referred to as network settings.

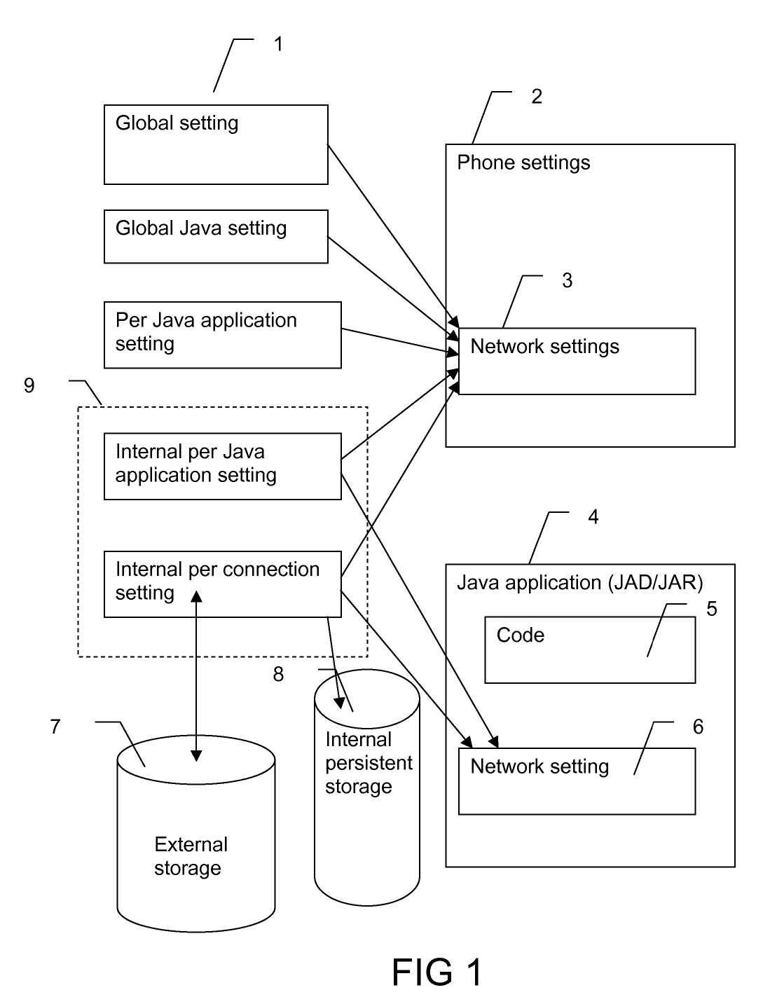

The current situation for Java network settings in mobile phones is as follows. See the network settings hierarchy 1 in FIG. 1.
It is possible to define global network settings implicitly for Java applications by not specifying any settings. Commonly the same network settings as used by the internet or the web browser are used as default settings.
It is possible to explicitly define device global network settings for Java applications in the phone. This setting overrides the implicit default settings.
It is possible to explicitly define the network settings for a specific Java application. This setting overrides global Java settings and web browser settings.

Today, the network settings are stored in the mobile station separately from the application. When a function involving an application is run, the mobile station uses default network settings, or global network settings if defined, or network settings based on the name of the application, if specific settings are defined.

The network settings document/information can be provided in three ways:
Explicitly entered by the end user for default, global and specific settings
Downloaded using e.g. SMS. Download is defined for default settings (web browser) but currently not defined for Global Java using OMA Network Provisioning content format. Today there is no SMS download mechanism for a specific Java Application.
Device Management. Mechanisms are defined for device global and used by operator, manufacturer, enterprise or any other entity given the authority.

It is difficult to handle Java applications that need specific network settings since the settings are handled separately from the installation of the Java application, and the settings are not easy to manage for ordinary users.

Today there exist numerous connection methods and networks to select from for a given function. For some functions, it is even possible to use more than one connection at the same time. However, there is no possibility to define the network settings on a per connection basis.

### SUMMARY OF THE INVENTION

An object of the invention is to simplify entering of network settings in the mobile station. Another object is to enable application specific network settings downloaded together with the application. A further object is to enable per connection network settings. A further object is to enable dynamic network settings. A still further object is to enable referencing network settings in the mobile station from within an application.

The invention provides an application comprising code for running in a mobile station platform, including one function involving connection over a network, wherein the application further comprises information referring to network settings.

In one embodiment, said information is dependent of a connection to be established by the application.

Said information may be dependent of a plurality of connections, so that different connections are associated with different network settings.

The application may be adapted to allow communication over more than one network, possibly at the same time.

In one embodiment, said information contains a reference to network settings stored in a space directly accessible to the mobile station.

In a further embodiment, said information contains a reference to network settings stored in external storage.

In a still further embodiment, said information contains a reference to network settings stored in a space associated with the application itself.

In one embodiment, said network settings are accessible only to the application itself.

In another embodiment, said network settings are accessible to the application itself and other applications.

Said network settings may be stored in a JAR file or in a JAD/Manifest attribute.

Suitably, said network settings comprise a prioritized list of network settings.

In one embodiment, said network settings comprise different prioritized lists of network settings, each list being associated with a different connection.

The mobile station may be a portable telephone, a pager, a communicator, a smart phone, or an electronic organiser.

### BRIEF DESCRIPTION OF THE DRAWINGS

The invention will be described below with reference to the accompanying drawings, of which the only FIGURE is a schematic diagram of a network setting hierarchy in connection with a mobile station.

### DETAILED DESCRIPTION OF PREFERRED EMBODIMENTS

The invention will be described with a mobile telephone as an example. The invention is equally applicable to other devices, such as pagers, communicators, smart phones, electronic organisers, computers, personal digital assistants (PDAs), and other telecommunication terminals. This disclosure will concentrate on the technical aspects relevant to the invention, while other functions necessary for the operation of the device may be conventional.

The main ideas are to include network setting information in the Java application and being able to control network settings per data connection.

Including network settings information in the application will remove the problems for the end user or alternatively operator to keep network settings in an updated and correct way. Per connection control is something completely new for Java MIDP applications.

With reference to FIG. 1, a representation of a network settings hierarchy 1 is shown to the left and a representation of the storage of the network settings 3 is shown to the right. The storage may be in the device's internal memory for phone settings 2 in general or an external memory. The network settings consist of or include pointers to documents or information files containing the network settings as such. In the prior art these network settings were stored separately from the application to which they pertained.

A network setting could include a prioritized list of alternatives depending on availability e.g. WiFi (wireless LAN, local area network), Bluetooth PAN (personal area network), HSDPA (high speed downlink packet access), 3G, EDGE (Enhanced Data rates for Global Evolution), GPRS (General Packet Radio Service), and circuit switched data.

An application 4 according to an embodiment of the invention is shown in FIG. 1. As is conventional the code 5 defining the operation of the application is contained in a JAR (Java ARchive) file. In addition, the application also includes a network setting 6. Generally, this could be a direct reference to a document containing the network settings as such.

The network setting of the application is also represented by the dashed box 9 in the network settings hierarchy 1. According to embodiments of the invention, the network settings as such may be stored in different places. There are three basic alternatives.

First, the application refers to network settings stored in the mobile station. Thus, the Java application may invoke settings from within the application but downloaded separately from the Java application. The storage may be as in the prior art as denoted by the network settings 3 and the network settings may be shared by other applications.

Second, the application refers to network settings 6 stored in the application 4 itself. Thus, the reference is internal of the application and the network setting as such is contained in the JAR file. Such internal network settings 6 may be arranged to be accessible to other applications, or only to the application itself, as desired. In one embodiment, an OMA Network Provisioning Document (or other format) is inserted in the Java JAR file and a JAD (Java application descriptor)/Manifest attribute is defined to reference a network setting in the document. In other embodiments, the setting information is included in the JAD/Manifest attribute, a Java constant or any other representation within the application 4.

Third, the application refers to network settings stored in an external storage 7, such as a server connectable over the telecommunications network, or another device connectable over a local network. Thus, the reference is to information external of the application and the mobile device. When an application encounters a reference to external network settings, the device establishes a connection with a specified external storage such as a server (using default network settings) and retrieves information about network settings and stores it in a suitable file in the device. If an existing specific setting is used and there is a new setting available e.g. a less expensive setting, this is negotiated and the application can adapt dynamically. When the external network settings are updated in the external storage the network settings pertaining to the application will follow. Thus, the network settings of the application are dynamically updated.

As described in the FIG. 1 network settings information could dynamically be downloaded/transferred to the application and used. Download/transfer should be possible from anywhere e.g. another phone, through SMS, MMS, phone file system etc. It could optionally be persistently stored in a Java related persistent storage 8 in the phone and be used at a later time.

According to a further embodiment, an application may contain references to network settings on a per connection basis. For example, within a company's premises it may be possible to establish connections over a local network (e.g. an intranet accessed through a Bluetooth connection) and over a national mobile telecommunications network (WAP/GPRS) to the Internet. In the application, network settings are defined differently for the different connections. For instance, security levels, transmission rates may be different for the local network connection and the Internet connection. In one embodiment, it is possible to define the network settings for all connections within that specific application (unless overridden).

The possibility to define network settings on a per connection basis will further improve the use of alternative network connections, such as VPN (virtual private network), IPSec (security at IP level), WiFi & Bluetooth PAN.

E.g. an enterprise application could be downloaded with included network settings to perform secure VPN communication to applications inside of the corporate firewall without the user having to be bothered with setting up any network settings.

Also the possibility to communicate both over the radio network and in a local network in the same application at the same time gives many new possibilities.

As is shown in FIG. 1, the hierarchy 1 of the network settings is increased by further levels. From top to bottom, the levels are global (default) setting, global Java setting, per application Java setting (defined externally of the application), internal per application Java setting, and internal per connection setting. In the hierarchy shown in the figure, a lower setting overrides a higher setting.

The invention may be implemented by means of hardware and software as will be appreciated by a person skilled in the art. The scope of the invention is only limited by the claims below.

1. An application comprising code for running in a mobile station platform, including one function involving connection over a network, wherein the application further comprises information referring to network settings.

2. An application according to claim 1, wherein said information is dependent of a connection to be established by the application.

3. An application according to claim 2, wherein said information is dependent of a plurality of connections, so that different connections are associated with different network settings.

4. An application according to claim 3, wherein the application is adapted to allow communication over more than one network.

5. An application according to claim 4, wherein the application is adapted to allow communication over more than one network at the same time.

6. An application according to claim 1, wherein said information contains a reference to network settings stored in a space directly accessible to the mobile station.

7. An application according to claim 1, wherein said information contains a reference to network settings stored in external storage.

8. An application according to claim 1, wherein said information contains a reference to network settings stored in a space associated with the application itself.

9. An application according to claim 8, wherein said network settings are accessible only to the application itself.

10. An application according to claim 8, wherein said network settings are accessible to the application itself and other applications.

11. An application according to claim 8, wherein said network settings are stored in a JAR file.

12. An application according to claim 8, wherein said network settings are stored in a JAD/Manifest attribute.

13. An application according to claim 8, wherein said network settings comprise a prioritized list of network settings.

14. An application according to claim 13, wherein said network settings comprise different prioritized lists of network settings, each list being associated with a different connection.

15. An application according to claim 1, wherein the mobile station is a portable telephone, a pager, a communicator, a smart phone, or an electronic organiser.
